(19) United States
(12) Patent Application Publication
(10) Pub. No.: US 2010/0265315 A1
(43) Pub. Date: Oct. 21, 2010

(54) THREE-DIMENSIONAL IMAGE COMBINING APPARATUS

(75) Inventors: TADAYOSHI OKUDA, OSAKA (JP); SHINICHI KAWAKAMI, OSAKA (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/763,452

(22) Filed: Apr. 20, 2010

(30) Foreign Application Priority Data
Apr. 21, 2009 (JP) 2009-102586

(51) Int. Cl. H04N 13/00

(52) U.S. Cl. 348/43

(57) ABSTRACT

A three-dimensional image combining apparatus includes an obtaining unit configured to obtain data of a main image as an image enabling stereoscopic view, data of an additional image to be combined with the main image and be displayed, and position information for defining a display position in a depth direction of the additional image in stereoscopic view of the additional image, a scaling unit configured to upscale or downscale the main image, an adjusting unit configured to adjust the position information based on a magnification of upscaling or downscaling the main image, and a combining unit configured to combine the additional image with the upscaled or downscaled main image based on the adjusted position information so that the additional image can be viewed stereoscopically.

### BACKGROUND

1. Technical Field

The technical field relates to an image combining apparatus capable of combining an additional image with a main image to be displayed as a three-dimensional (3D) image.

2. Related Art

JP2004-274125A discloses an image combining apparatus that combines a subtitle image with a main image. Further, JP2004-274125A discloses a technique for multiplexing parallax information of the subtitle image, the main image, and the subtitle image so as to display a subtitle image on a suitable position of the main image, and for storing the multiplexed image.

Specifically, on a side of editing 3D image data, a main image as 3D image, a subtitle image as 3D image, and parallax information of the subtitle image (information indicating a display position in a depth direction) are generated. On the editing side, the generated main image, subtitle image and parallax information of the subtitle image are multiplexed and the multiplexed image is stored as a 3D image stream.

A reproducing apparatus for displaying 3D images splits a 3D image stream to obtain the main image, the subtitle image, and the parallax information, and combines the subtitle image with the main image based on the parallax information of the subtitle image. The reproducing apparatus displays the combined image. As a result, the subtitle image is displayed on a position suitable for the main image.

The 3D image stream may include not only the subtitle image but also sub-image (such as a pop-up menu and bonus view images). In such a case, the 3D image stream should include parallax information of the sub-image as well as the sub-image.

The main image included in the 3D image stream is not always displayed on a entire screen, and thus is occasionally downscaled to be displayed. For example as shown in FIG. 14, in some cases, a sub-image 52 is displayed on an entire screen, and a main image 50 is downscaled and displayed on a partial area of the sub-image 52. At this time, a subtitle image 54 should be also downscaled similarly to the main image 50, and combined with the main image 50. In the combining, when the subtitle image is combined with the main image without suitably adjusting parallax information of the subtitle image, a 3D image based on the combined image may become an uncomfortable image. For example, a subtitle may appear to be embedded into an object represented by the main image.

When a main image and a subtitle image are standard definition (SD) images such as an image according to NTSC and PAL and a sub-image is a high definition (HD) image (an image whose vertical definition is 1080 or 720 lines), the main image and the subtitle image should be subject to an upscaling process in order to combine the main image and the subtitle image with the sub-image. This is because the image signals of NTSC and PAL are generated based on rectangle pixels and the HD image signal is generated based on square pixels. Also in this case, when the subtitle image is combined with the main image without adjusting parallax information, the combined image becomes an uncomfortable image.

Image combining technique which allows a user to view a 3D image without uncomfortable feeling when the main image is upscaled or downscaled and displayed, are demanded.

### SUMMARY

In order to solve the above problem, the image combining apparatus is provided, which has a simple configuration and can adjust suitably a display position, in a depth direction, of an additional image (subtitle image or a sub-image) added to a main image of a 3D image even when the main image is upscaled or downscaled.

A first aspect provides a three-dimensional image combining apparatus that includes an obtaining unit configured to obtain data of a main image as an image enabling stereoscopic view, data of an additional image to be combined with the main image and be displayed, and position information for defining a display position in a depth direction of the additional image in stereoscopic view of the additional image, a scaling unit configured to upscale or downscale the main image, an adjusting unit configured to adjust the position information based on a magnification of upscaling or downscaling the main image, and a combining unit configured to combine the additional image with the upscaled or downscaled main image based on the adjusted position information so that the additional image can be viewed stereoscopically.

With the above arrangement, a combining position of the additional image with respect to the main image can be adjusted according to the upscaling or downscaling magnification of the main image. Accordingly, when a 3D image is provided to a user, the display position of the additional image in the depth direction can be suitably adjusted.

A second aspect provides a three-dimensional image combining apparatus for combining a main image as an image enabling stereoscopic view with a sub-image. The apparatus includes an obtaining unit configured to obtain data of the main image, data of an additional image to be combined with the main image and be displayed, and data of the sub-image, a first scaling unit configured to upscale or downscale the main image, a first combining unit configured to combine the upscaled or downscaled main image and the sub-image so that the upscaled or downscaled main image is displayed on a partial area of the sub-image, a second scaling unit configured to upscale or downscale the additional image, and a second combining unit configured to combine the upscaled or downscaled additional image with the combined image of the main image and the sub image.

With the above arrangement, the upscaling/downscaling magnifications of the main image and a subtitle image can be set independently, and the magnifications can be applied to generation of various sub-images.

A third aspect provides a three-dimensional image combining method, including obtaining data of a main image to be presented stereoscopically, data of an additional image to be combined with the main image and be displayed, and position information for defining a display position in a depth direction of the additional image in stereoscopic view of the additional image, upscaling or downscaling the main image, adjusting the position information based on a magnification of upscaling or downscaling the main image, and combining the additional image with the upscaled or downscaled main image based on the adjusted position information so that the additional image can be viewed stereoscopically.

A fourth aspect provides a three-dimensional image combining method for combining a main image as an image enabling stereoscopic view image and a sub-image. The three-dimensional image combining method includes obtaining data of the main image, data of an additional image to be combined with the main image and be displayed, and data of the sub-image, upscaling or downscaling the main image, combining the upscaled or downscaled main image and the sub-image so that the upscaled or downscaled main image is displayed on a partial area of the sub-image, upscaling or downscaling the additional image, and combining the upscaled or downscaled additional image with the combined image of the main image and the sub image.

With the above aspects, the display position of the additional image (for example, a subtitle image) to be added to the upscaled or downscaled main image in a depth direction can be suitably set, and a viewer can visually recognize the main image and the additional image without uncomfortable feeling.

### BRIEF DESCRIPTION OF DRAWINGS

FIG. 1 is a diagram illustrating a relationship between a 3D image display controller and other apparatuses.

FIG. 2 is a diagram illustrating an example of configuration of the 3D image display controller.

FIG. 3 is a diagram illustrating an example of configuration of a 3D image display apparatus.

FIGS. 4A and 4B are diagrams for describing a method for displaying a 3D image.

FIG. 5 is a diagram illustrating one example of a 3D image stream.

FIGS. 6A and 6B are diagrams for describing a case where a subtitle image and an apparatus image are superimposed on 3D image data.

FIG. 7 is a diagram for describing combining of a main image, a subtitle image, and a sub-image.

FIGS. 8A and 8B are diagrams for describing an example of displayed images when sub-image display is ON.

FIGS. 9A and 9B are diagrams for describing an example of adjustment of parallax information of the subtitle image when the main image is downscaled.

FIGS. 10A and 10B are diagrams for describing an example of adjustment of the parallax information of the subtitle image, in which the main image of NTSC or PAL is upscaled or downscaled and overlaid on a menu image with the aspect ratio 16:9.

FIGS. 11A to 11C are diagrams for describing an example of adjustment of the parallax information of the subtitle image, in which the main image of NTSC or PAL is upscaled and overlaid on the menu image with the aspect ratio 16:9.

FIG. 12 is a flowchart for describing an operation example of the 3D image display controller.

FIG. 13 is a diagram illustrating a function block of an AV input/output circuit relating to another image combining process.

FIG. 14 is a diagram for describing one example of a combined image which may cause a problem to be solved.

### DETAILED DESCRIPTION OF PREFERRED EMBODIMENT

An embodiment is described below with reference to accompanying drawings. A three-dimensional (3D) image display controller described in the following embodiment combines a main image and a subtitle image with a sub-image according to a predetermined procedure. When upscaling or downscaling a main image, the 3D image display controller adjusts (corrects) parallax information of a subtitle image to be combined with the main image according to an upscaling or downscaling magnification. The details thereof are described below.

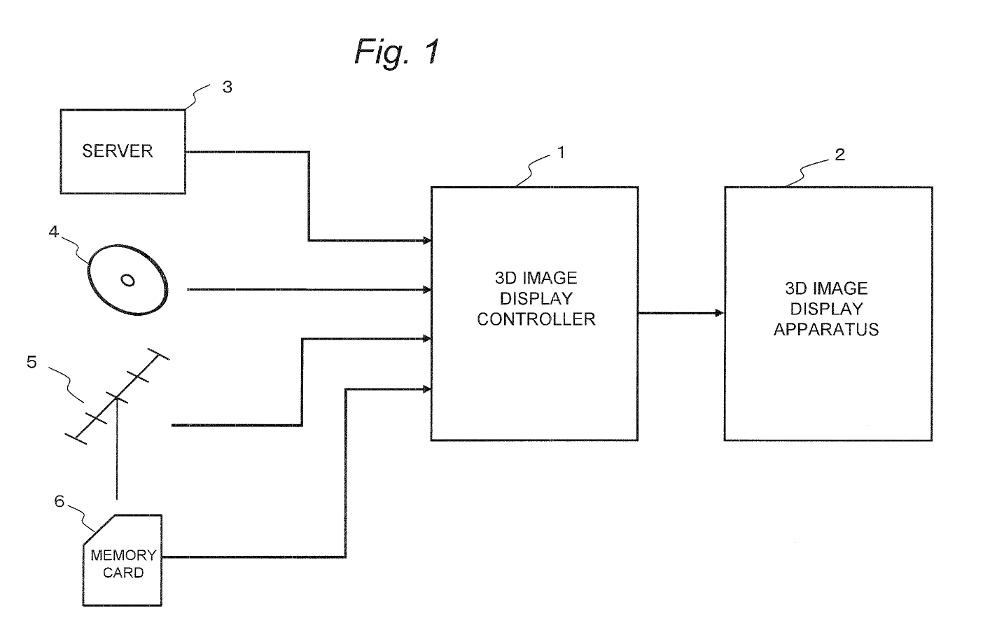

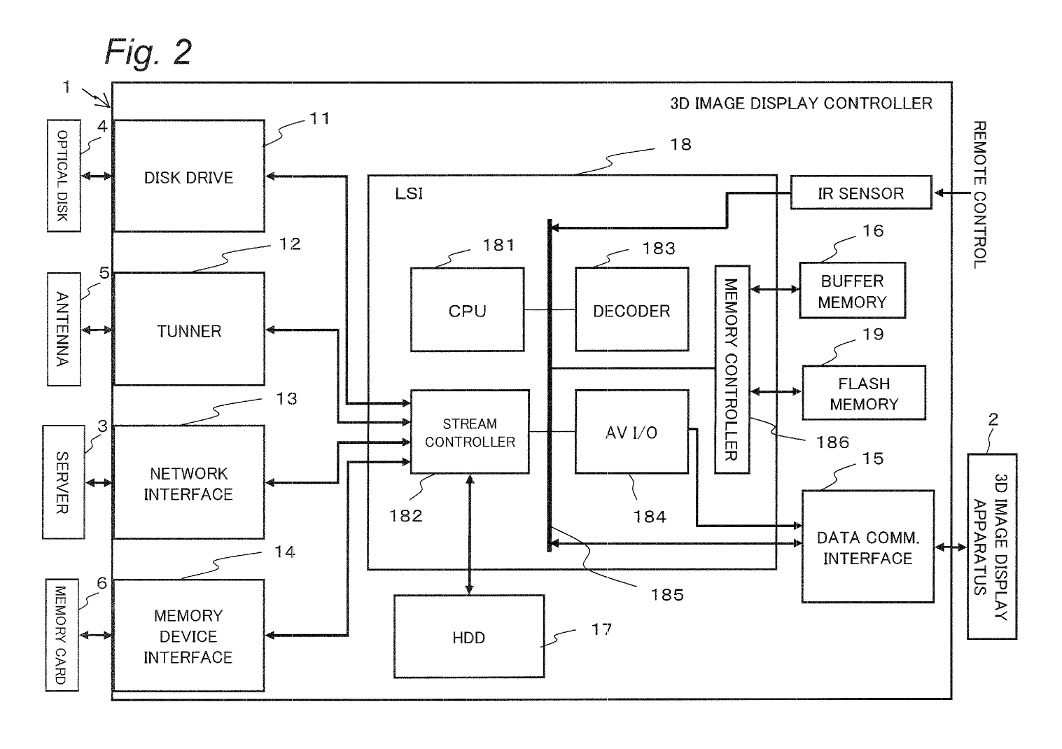

The 3D image display controller according to a preferred embodiment is described below. FIG. 1 is a diagram illustrating a relationship between the 3D image display controller 1 and another apparatus. FIG. 2 is a diagram illustrating a constitutional example of the 3D image display controller. This is specifically described below.

### 1. 3D Image Display System

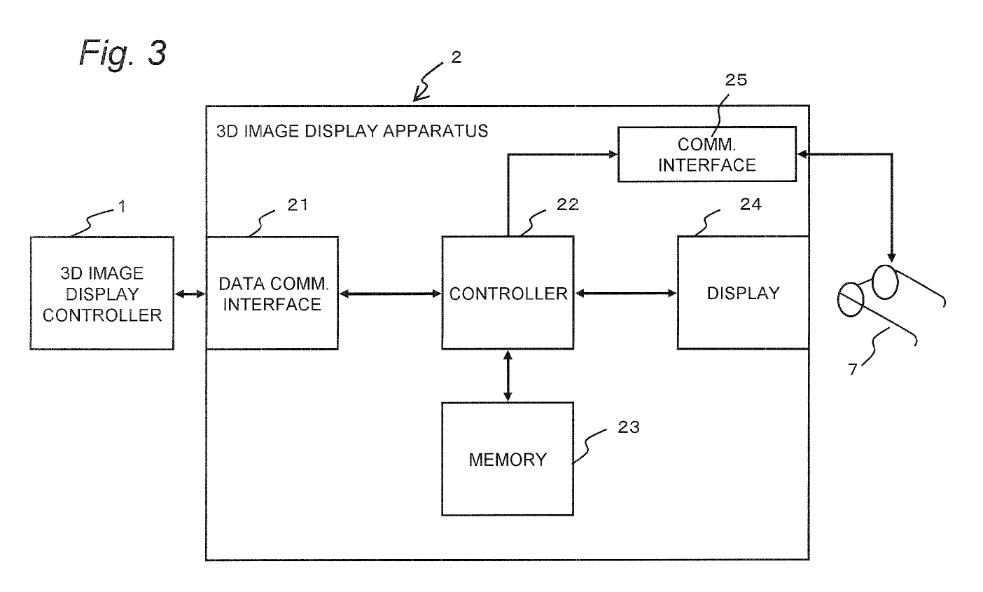

FIG. 1 illustrates a configuration of a 3D image display system according to the embodiment. The 3D image display system includes a 3D image display controller 1 and a 3D image display apparatus 2. FIG. 2 illustrates an example of configuration of the 3D image display controller 1. FIG. 3 illustrates an example of configuration of the 3D image display apparatus 2.

As shown in FIG. 1, the 3D image display controller 1 is connected to the 3D image display apparatus 2 for displaying a 3D image, a server 3 which stores 3D image streams, and an antenna 5. The 3D image display controller 1 is inserted with an optical disc 4 and a memory card 6. The 3D image display controller 1 obtains 3D image streams for displaying 3D images or information for generating the 3D image stream from the server 3, the optical disc 4, the antenna 5 or the memory card 6.

As shown in FIG. 3, the 3D image display apparatus 2 has a display 24 and displays image data. The display 24 is, for example, a liquid crystal display, a plasma display or an organic EL display. The 3D image display apparatus 2 can display the image data transmitted from the 3D image display controller 1. The 3D image display apparatus 2 can transmit information about a screen size to the 3D image display controller 1 in response to a request signal from the 3D image display controller 1.

More specifically, the 3D image display apparatus 2 includes a controller 22, a memory 23, the display 24, a data communication interface 21, and a communication interface 25.

The memory 23 stores in advance the information about the screen size of the 3D image display apparatus 2. The memory 23 can be, for example, a flash memory or FRAM.

When receiving the request signal from the 3D image display controller 1, the controller 22 reads the information about the screen size stored in the memory 23 and transmits the information to the 3D image display controller 1. Accordingly, the 3D image display controller 1 can obtain the information about the screen size from the 3D image display apparatus 2. The controller 22 can be, for example, a microprocessor.

The data communication interface 21 is an interface for transmitting/receiving data to/from the 3D image display controller 1. The data communication interface 21 can be implemented by, for example, an HDMI (High Definition Multimedia Interface) connector, and the like.

The communication interface 25 is an interface for communicating with active shutter glasses 7. The communication interface 25 establishes communication with the active shutter glasses 7 by means of, for example, wireless communication such as an infrared ray or Bluetooth, or a wired communication.

Referring to FIG. 1, the server 3 is a network server which stores 3D image streams. The server 3 is connected to the network, and can be connected to the 3D image display controller 1 installed in a home. The server 3 can transmit the 3D image stream to the 3D image display controller 1 (network communication interface 13) in response to an access request from the 3D image display controller 1.

The optical disc 4 is a recording medium which records 3D image streams. The optical disc 4 can be inserted into a disc drive 11 of the 3D image display controller 1. The 3D image display controller 1 (disc drive 11) can read the 3D image streams recorded in the optical disc 4.

The antenna 5 is an antenna for receiving a broadcast wave including a 3D image stream broadcasted by a broadcast apparatus of a broadcast station. The antenna 5 transmits the received broadcast wave including the 3D image stream to the 3D image display controller 1 (tuner 12).

The memory card 6 is a semiconductor memory card which records 3D image streams or a recording medium containing a semiconductor memory. The memory card 6 can be inserted into the 3D image display controller 1 (data communication interface 15). The 3D image display controller 1 (data communication interface 15) can read the 3D image streams recorded in the memory card 6.

### 2. Method for Displaying 3D Image

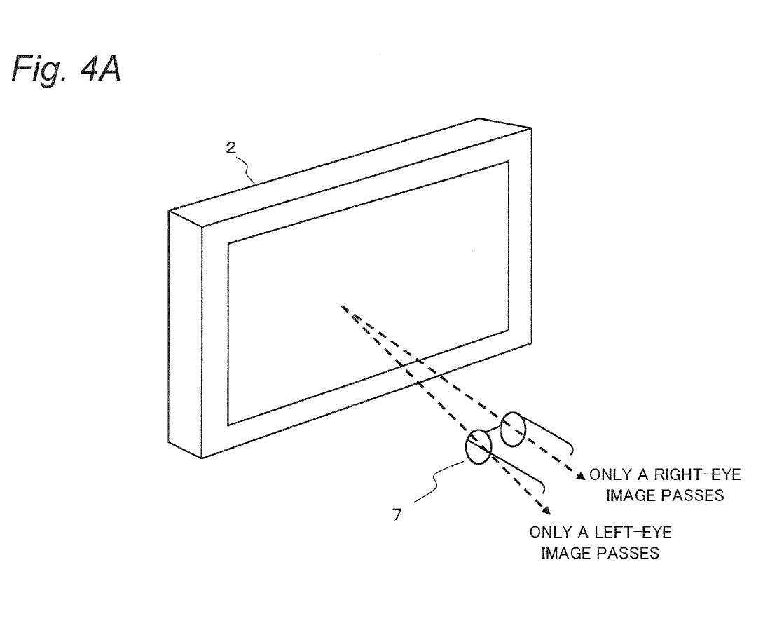

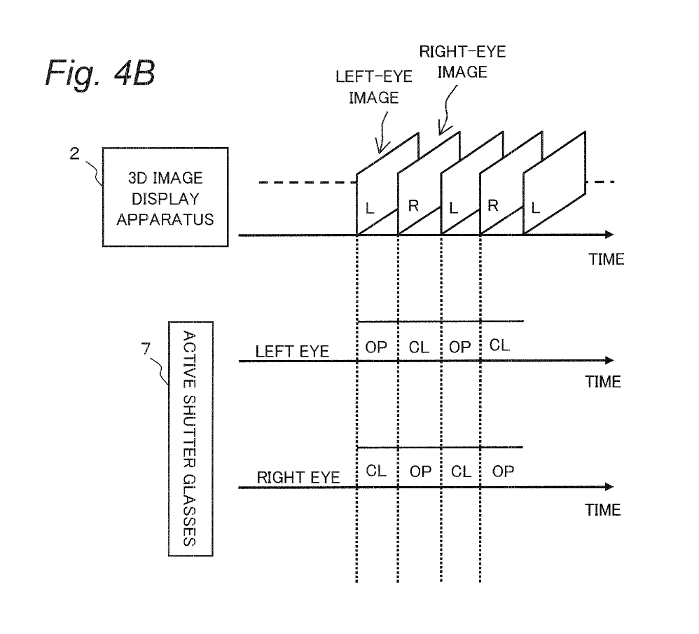

A method for displaying a 3D image is described with reference to FIGS. 4A and 4B. The 3D image display apparatus 2 displays an image for enabling the viewing of a 3D image (stereoscopic image) using the active shutter glasses 7 (see FIG. 4A). Specifically, the 3D image display controller 1 alternately outputs image data represented by an image for a left eye (hereinafter, “left-eye image”) and image data represented by an image for a right eye (hereinafter, “right-eye image) to the 3D image display apparatus 2. The 3D image display apparatus 2 sequentially displays screen data obtained from the 3D image display controller 1 on a screen of the display 24 (see FIG. 4B). The user views the image displayed on the 3D image display apparatus 2 in such a manner through the active shutter glasses 7 so as to be capable of recognizing the 3D image (stereoscopic image).

The active shutter glasses 7 have a shutter that can shut either one of right and left visual fields. When a left-eye image is displayed on the 3D image display apparatus 2, the active shutter glasses 7 shut the visual field of a user's right eye for the 3D image display apparatus 2. Whereas, when a right-eye image is displayed on the 3D image display apparatus 2, the active shutter glasses 7 shut the visual field of a user's left eye for the 3D image display apparatus 2. In this manner, as shown in FIGS. 4A and 4B, when the screen displays the left-eye image on the 3D image display apparatus 2, the user views the image with the left eye, and when the screen displays the right-eye image on the 3D image display apparatus 2, the user views the image with the right eye. Accordingly, the user can visually recognize the screens sequentially displayed on the 3D image display apparatus 2 as a 3D image.

The embodiment describes an example using the active shutter glasses 7, but the embodiment is not limited to this method as long as the user can view a right-eye image and a left-eye image displayed on the 3D image display apparatus 2 separately.

### 3. 3D Image Stream

In the embodiment, a 3D image stream that is obtained by the 3D image display controller 1 from the server 3, the optical disc 4, the antenna 5, or the memory card 6 has the following structure.

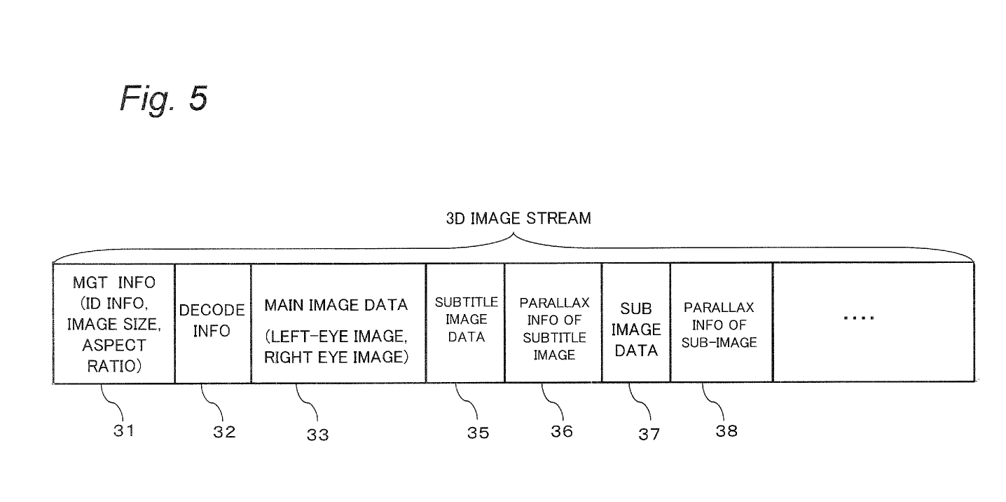

FIG. 5 illustrates one example of the structure of the 3D image stream. The 3D image stream includes management information 31, decode information 32, main image data 33, subtitle image data 35, parallax information 36 about the subtitle image, sub-image data 37, and parallax information 38 about the sub-image.

The main image data 33, the subtitle image data 35, the parallax information 36 about the subtitle image, the sub-image data 37, and the parallax information 38 about the sub-mage are encoded by an any compressing method. As the compressing method, MVC (Multi-view Video Coding) and MPEG4-AVC/H.264 are considered, but the compressing method is not limited to them. Compressed 3D image data includes information (decode information) necessary for decode because the data is compressed by the above compressing method.

The management information 31 includes an image size and image aspect for the main image, subtitle image, and sub-image, respectively.

The main image data 33 includes a left-eye image and a right-eye image captured by right and left cameras of a compound-eye camera.

The parallax information 36 about the subtitle image represents as to how much the subtitle image is shifted from the left-eye image and the right-eye image so as to be overlapped on the left-eye and right-eye images. In the embodiment, the parallax information of the subtitle image represents a relative shift amount with respect to a main image. For example, when the parallax information of the subtitle image is Y pixels, the subtitle image is shifted from the left-eye main image to a right direction by the Y pixels and is overlapped on the left-eye main image, and the subtitle image is shifted from the right-eye main image to a left direction by the Y pixels so as to be overlapped on the left-eye main image. Also the parallax information 38 about the sub-image (for example, X) is handled similarly to the parallax information 36 about the subtitle image. The parallax information representing the shift amount is expressed by a pixel unit, but not limited to this, and it may be expressed by a unit of mm.

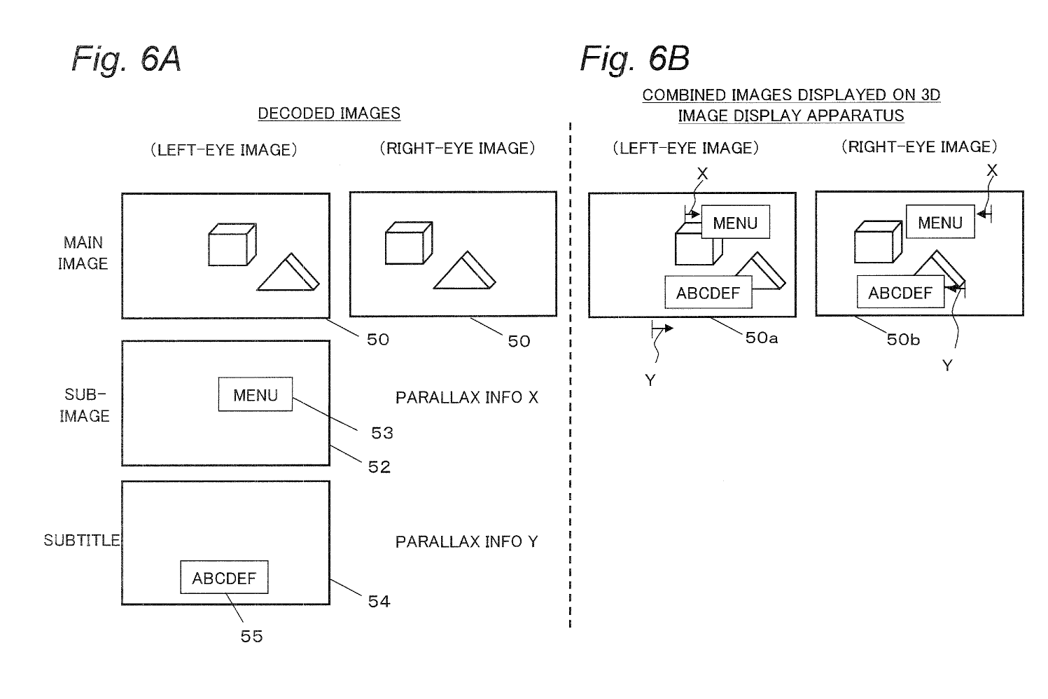

The 3D image display controller 1 obtains the aforementioned information from the 3D image stream, combines the subtitle image or the sub-image with the main image so as to be capable of displaying the combined image on the 3D image display apparatus 2. FIGS. 6A and 6B are diagrams for describing the combining of the main image, the subtitle image, and the sub-image. A main image 50, a subtitle image 54, and a sub-image 52 shown in FIG. 6A are combined to generate a combined image shown in FIG. 6B. At this time, in right and left combined images 50a and 50, the combining is carried out so that a menu icon 53 and a subtitle 55 are shifted from the main image by the parallax information X and Y.

### 4. Configuration of 3D Image Display Controller

A configuration of the 3D image display controller 1 is described. Referring back to FIG. 2, the 3D image display controller 1 has the disc drive 11, the tuner 12, the network communication interface 13, a memory device interface 14, the data communication interface 15, a buffer memory (frame memory) 16, an HD drive 17, a flash memory 19, and an LSI 18.

The disc drive 11 includes an optical pickup, and reads a 3D image stream from the optical disc 4. The disc drive 11 is connected to the LSI 18, and transmits the 3D image stream read from the optical disc 14 to the LSI 18. The disc drive 11 reads the 3D image stream from the optical disc 4 according to control from the LSI 18 so as to transmit the stream to the LSI 18.

The tuner 12 obtains a broadcast wave including the 3D image stream received by the antenna 5. The tuner 12 takes out the 3D image stream of a frequency specified by the LSI 18 from the obtained broadcast wave. The tuner 12 is connected to the LSI 18, and transmits the taken-out 3D image stream to the LSI 18.

The network communication interface 13 can be connected to the server 3 via a network. The network communication interface 13 obtains the 3D image stream transmitted from the server 3.

The memory device interface 14 is constituted so that the memory card 6 can be inserted, and can read the 3D image stream from the inserted memory card 6. The memory device interface 14 transmits the 3D image stream read from the memory card 6 to the LSI 18.

The HD drive 17 contains a recording medium such as a hard disk, and transmits data read from the recording medium to the LSI 18. The HD drive 17 records the data received from the LSI 18 on the recording medium.

The data communication interface 15 is an interface that transmits the data transmitted from the LSI 18 to the external 3D image display apparatus 2. The data communication interface 15 can transmit/receive a data signal and a control signal to/from the 3D image display apparatus 2. Therefore, the LSI 18 can control the 3D image display apparatus 2 via the data communication interface 15. The data communication interface 15 can be implemented by, for example, an HDMI connector and the like. The data communication interface 15 may have any configuration as long as it can transmit the data signal to the 3D image display apparatus 2.

The buffer memory 16 functions as a work memory when the LSI 18 executes a process. The buffer memory 16 can be, for example, DRAM or SRAM.

The flash memory 19 stores an apparatus image in advance. The apparatus image includes, for example, images representing information about a channel, information about a volume, information for adjusting brightness of a display, a contrast amount, and color temperature, and information for adjusting image quality of a reproducing apparatus. In other words, the LSI 18 allows the 3D image display apparatus 2 to display the apparatus image read from the flash memory 19 with it being overlapped with the image data. In this manner, the LSI 18 can present information regarding the apparatus to a viewer. Further, the LSI 18 displays a setting screen for the viewer to receive settings from the viewers.

The LSI 18 is a system controller that controls the respective sections of the 3D image display controller 1. The LSI 18 may be a microcomputer, or a hard-wired circuit.

A CPU 181, a stream controller 182, a decoder 183, an AV input/output circuit 184, a system bus 185, and a memory controller 186 are mounted into the LSI 18.

The CPU 181 controls the entire LSI 18. The respective sections of the LSI 18 make various controls under control of the LSI 118. The CPU 181 controls also communication with an outside. When obtaining a 3D image stream from the server 3, the CPU 181 transmits a control signal to the disc drive 11, the tuner 12, the network communication interface 13, or the memory device interface 14. Accordingly, the disc drive 11, the tuner 12, the network communication interface 13, and the memory device interface 14 can obtain the 3D image stream from the recording medium, a broadcast station, or the like.

The stream controller 182 controls the transmission/reception of data with the server 3, the optical disc 4, the antenna 5, the memory card 6, and the active shutter glasses 7. For example, the CPU 181 transmits the 3D image stream obtained from the server 3 to the memory controller 186.

The memory controller 186 writes the data transmitted from the respective sections of the LSI 18 into the buffer memory 16. For example, the memory controller 186 records the 3D image stream obtained from the stream controller 182 in the buffer memory 16. Further, the memory controller 186 reads the data recorded in the buffer memory 16 from the buffer memory 16. The buffer memory 16 transmits the read data to the respective sections of the LSI 18.

When the decoder 183 obtains the data from the memory controller 186, the decoder 183 decodes the obtained data. The data to be inputted into the decoder 183 is based on the control of the CPU 181. Specifically, the CPU 181 controls the memory controller 186 to cause the memory controller 186 to read the 3D image stream recorded in the buffer memory 16. The CPU 181 controls the memory controller 186 to cause the memory controller 186 to transmit the read 3D image stream to the decoder 183. Accordingly, the 3D image stream is inputted from the memory controller 186 to the decoder 183.

The decoder 183 decodes the compressed 3D image stream based on the decode information included in the 3D image stream. The decoder 183 transmits the decoded information to the memory controller 186. The memory controller 186 records the obtained information in the buffer memory 16.

The AV input/output circuit 184 reads information from the buffer memory 16, and generates a display image to be displayed on the 3D image display apparatus 2. The AV input/output circuit 184 transmits the generated display image to the 3D image display apparatus 2 via the data communication interface 15.

When the subtitle image (or the sub-image to be added to the 3D image) is set to be overlapped with the 3D image data, the AV input/output circuit 184 conducts the following control.

The AV input/output circuit 184 obtains the subtitle image data 35 and the parallax information 36 about the subtitle image from the buffer memory 16, and overlaps the subtitle image with the left-eye image or the right-eye image based on the parallax information 36 about the subtitle image. For example, when the parallax information (shift amount) about the subtitle image is Y pixels as shown in FIG. 6B, the AV input/output circuit 184 shifts a subtitle image 51 from a left-eye image 50a to the right direction by the Y pixels and overlaps the subtitle image 51 on the left-eye image 50a, and shifts the subtitle image 51 from a right-eye image 50b to the left direction by the Y pixels and overlaps the subtitle image 51 on the right-eye image 50b. The same holds for a sub-image 53 to be added to the 3D images 50a and 50b.

The AV input/output circuit 184 sets as to whether the subtitle image is overlapped with the main image, namely, whether the subtitle image overlapped with the main image is displayed, based on a signal inputted by a user's operation of a remote controller via an infrared ray sensor. The state that the subtitle image is displayed is referred to as the “subtitle display ON”, and the state that the subtitle image is not displayed is referred to as the “subtitle display OFF”. The user can switch ON and OFF of the subtitle image by means of the operation of the remote controller. ON and OFF of the display of the sub-image is also switched similarly to the subtitle image.

5. Sub-Image Combined with Downscaled Main Image

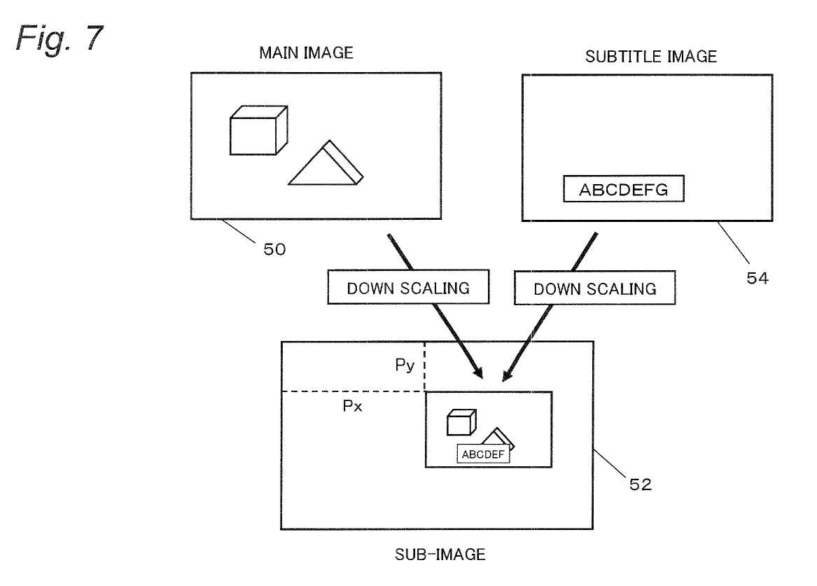

One example of the sub-image is an image which is displayed across the screen and has a downscaled main image displayed on a partial area of the sub-image. Such a screen of the sub-image includes a function selecting screen for enabling the user to select various additional functions. FIG. 7 illustrates an example of such a sub-image. FIG. 7 shows that the downscaled main image 50 and subtitle image 54 are arranged on a partial area of the sub-image 52. The main image 50 and the subtitle image 54 are arranged with a position separated from a standard position (in FIG. 7, an upper left end) of the sub-image by an offset value (Px, Py) being a start position. Information about the offset value (Px, Py) is included in the management information 31.

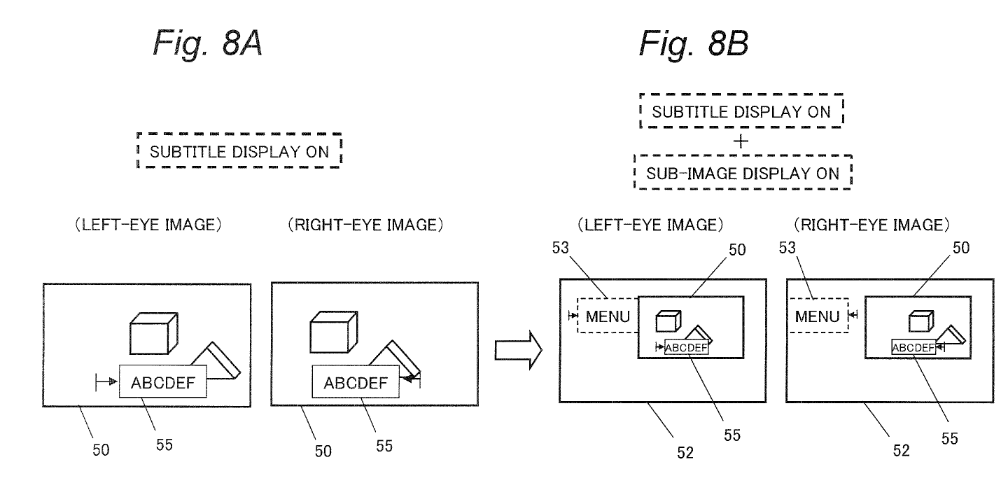

FIG. 8A is a diagram illustrating an example of display when the subtitle display is ON. When the display of the sub-image is made to be ON in the state shown in FIG. 8A, the sub-image 52 is displayed across the screen as shown in FIG. 8B. The downscaled main image 50 is displayed on a partial area of the sub-image 52. In this case, the subtitle 55 is also downscaled and is displayed on a partial area of the sub-image 52. In the case of FIG. 83, a combining position of a display icon 53 such as a menu item included in the sub-image 52 is adjusted within the area of the sub-image 52 based on the parallax information of the sub-image 52.

When such a sub-image is set to be displayed, the AV input/output circuit 184 sets a magnification so that the main image can be combined on the partial area of the sub-image, and downscales the main image with the set magnification. Further, the AV input/output circuit 184 downscales also the subtitle image according to the magnification for downscaling of the main image. Further, in the embodiment, the AV input/output circuit 184 adjusts the parallax information of the subtitle image according to the magnification for downscaling of the main image.

The AV input/output circuit 184 combines the subtitle image with the main image based on the adjusted parallax information of the subtitle image, and then combines the main image combined with the subtitle image with the sub-image. The AV input/output circuit 184 outputs the combined image data to the 3D image display apparatus 2 via the data communication interface 15.

In this way, even when the main image is upscaled or downscaled, the 3D image display controller 1 can adjust the parallax information of the subtitle image with a simple configuration. Although not shown in the figure, a power supply is connected to the respective sections of the 3D image display controller 1, supplying power from the power supply.

### 6. Adjustment of Parallax Information of Subtitle Image

In the embodiment, when the 3D image display controller 1 (namely, the AV input/output circuit 184) combines the upscaled or downscaled main image and subtitle image with the sub-image, it adjusts the parallax information of the subtitle image based on the upscaling or downscaling magnification of the main image. The following describes various examples of the adjustment of the parallax information of the subtitle image according to the upscaling or downscaling magnification of the main image.

### 6.1 First Example of Adjustment of Parallax Information

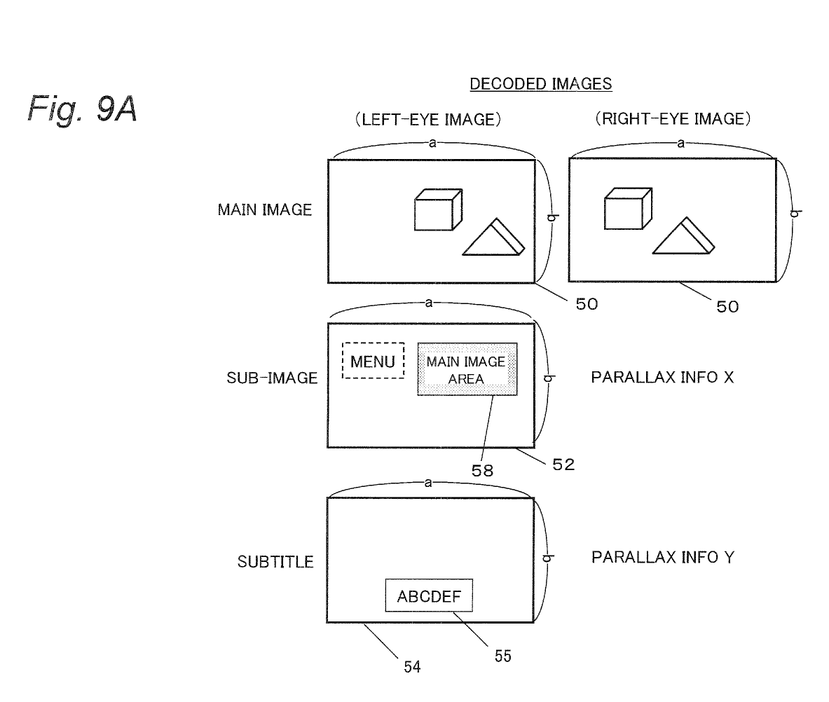

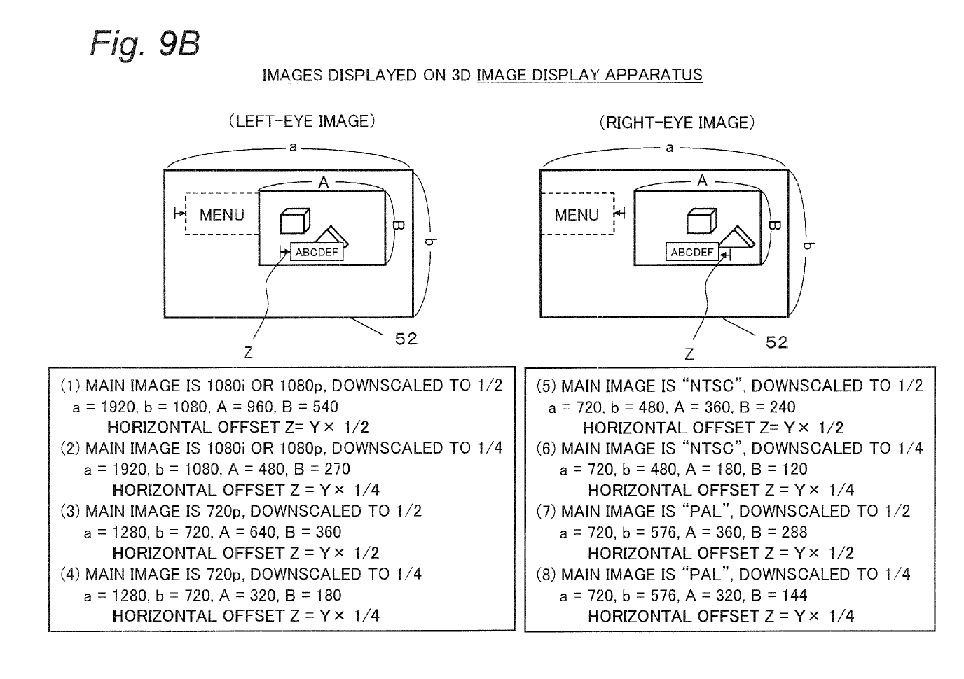

The first example of adjustment of the parallax information is described below. The description refers to adjustment of the parallax information of the subtitle image (horizontal offset amount Z) when the main image 50 and the subtitle image 54 shown in FIG. 9A are combined to generate a combined image shown in FIG. 9B.

In FIG. 9A, the sub-image 52 has an area 58 where the main image is arranged. The subtitle image 54 includes subtitle information 55. An area of the subtitle image 54 other than the subtitle information 55 is a transparent area. The main image 50 includes a left-eye image and a right-eye image, but the sub-image 52 and the subtitle image 54 have one image and parallax information.

FIG. 9B illustrates the parallax information of the subtitle image (horizontal offset amount Z) under conditions (1) to (4). The condition (1) indicates a condition for the case in which the main image 50, the subtitle image 54, and the sub-image 52 are HD (High Definition) images having 1080 or 720 effective scanning lines, and the main image and the subtitle image are downscaled and displayed within the sub-image. The conditions (5) to (8) indicates conditions for the case in which the main image 50, the subtitle image 54, and the sub-image 52 are SD (Standard Definition) images of NTSC and PAL having 480 or 576 effective scanning lines, and the main image 50 and the subtitle image 54 are downscaled and displayed within the sub-image 52.

In the example of FIG. 9B, when the display of the sub-image is ON, the main image and the subtitle image are downscaled and combined with the sub-image. At that time, the parallax information of the subtitle image is adjusted according to the downscaling magnification of the main image.

For example, like the condition (1) in FIG. 9B, when the main image of 1920 pixels×1080 pixels is downscaled to an image of 960×540 pixels (namely, downscaled to ½), the adjusted parallax information of the subtitle image (horizontal offset amount Z) is obtained by Y×½. Here, Y is the original parallax information of the subtitle image. This is described in detail blow.

The condition (1) in FIG. 9B premises the image stream under the following condition.

<Image Stream>

| | |
|---|---|
| Main image | Frame aspect: 16:9 |
| | The number of pixels: 1920 × 1080 |
| | Scaling factor: 1/2 |
| Subtitle image | Frame aspect: 16:9 |
| | The number of pixels: 1920 × 1080 |
| Sub-image | Frame aspect: 16:9 |
| | The number of pixels: 1920 × 1080 |

The frame aspect is an aspect ratio of an image. The number of pixels is resolution (size) of an image, and is expressed by the number of pixels in a horizontal direction and a vertical direction of an image. The scaling factor is upscaling or downscaling magnification in the horizontal and vertical directions at the time of combining a main image with a sub-image (background image). By specifying the scaling factor, a creator of a stream can arbitrarily specify the upscaling or downscaling magnification of a main image at the time of displaying a sub-image. The aforementioned information is included in the management information 31.

When combining the main image 50 and the subtitle image 54 with the sub-image 52, the AV input/output circuit 184 determines whether the pixel aspect is different between the sub-image 52, and the main image 50 and the subtitle image 54. The pixel aspect is a ratio of vertical pixels and horizontal pixels. When the pixel aspect is different, pixel conversion is necessary.

The AV input/output circuit 184 determines the pixel aspect based on the frame aspect and the number of pixels of each image. In this example, since the pixel aspects of the main image, the subtitle image, and the sub-image are 1:1 (square pixel) and are equal, the pixel conversion is not carried out, and only the scaling process based on the scaling factors is executed.

The AV input/output circuit 184 downscales the main image according to the scaling factor (=½). For example, when the scaling factor is ½, the AV input/output circuit 184 downscales the main image of 1920×1080 pixels to the image of 960×540 pixels. At this time, the AV input/output circuit 184 downscales the subtitle image based on the scaling factor used for the downscaling of the main image 50.

Further, the AV input/output circuit 184 adjusts the parallax information of the subtitle image 54 based on the scaling factor. Thereafter, the AV input/output circuit 184 combines the downscaled main image and subtitle image with the sub-image.

In the condition (6) as another example, the main image 50 of 720×480 pixels is downscaled to the main image of 180×120 pixels based on the scaling factor (=¼). In this case, the adjusted parallax information (Z) is obtained by Y×¼ based on the downscaling magnification (¼) of the main image.

In the above example, since the pixel aspects are equal to each other, the pixel conversion is not carried out, and the parallax information (Z) is adjusted based on only the scaling factor of the main image.

### 6.2 Second Example of Adjustment of Parallax Information

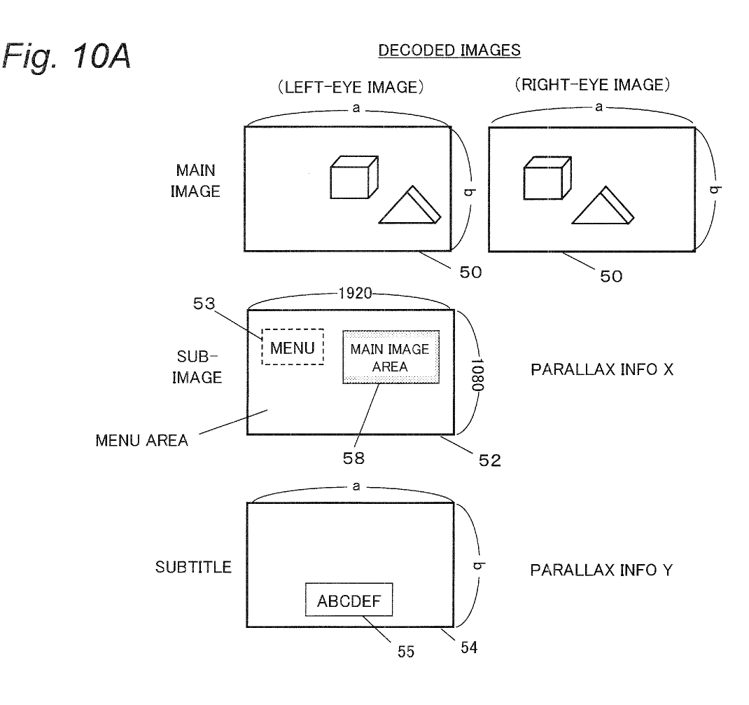

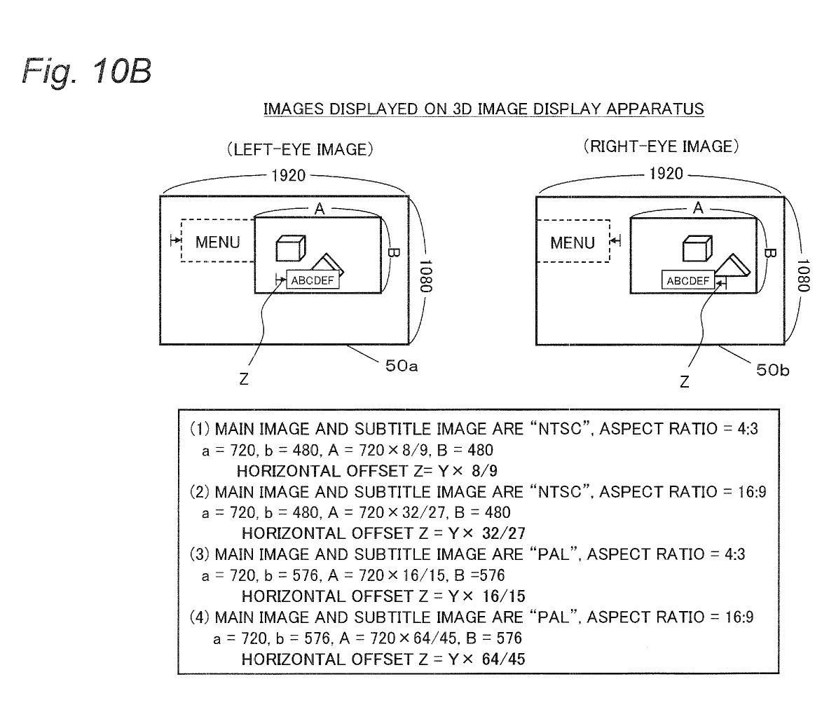

A second example of adjustment of the parallax information is described below. The description refers to the adjustment of the parallax information of the subtitle image (horizontal offset amount Z) when the main image 50 and the subtitle image 54 shown in FIG. 10A are combined to generate a combined image shown in FIG. 10B.

FIG. 10B illustrates the parallax information of the subtitle image (horizontal offset amount Z) under the conditions (1) to (4). The conditions (1) to (4) indicate conditions for displaying the upscaled or downscaled main image 50 on a partial area 58 of the sub-image 52, when both the main image 50 and the subtitle image 54 are SD images and the sub-image 52 is an HD image.

When the display of the sub-image is made to be ON, the parallax information of the subtitle image is adjusted, according to the upscaling or downscaling magnification of the main image in consideration of the pixel conversion.

For example, like the condition (1) in FIG. 10B, when the main image of 720×480 pixels is downscaled to an image of 640×480 pixels, the adjusted parallax information (Z) about the subtitle image can be obtained by Y× 8/9. This is described in detail below.

The condition (1) in FIG. 10B premises the image stream under the following condition.

<Image Stream>

| | |
|---|---|
| Main image | Frame aspect: 4:3 |
| | The number of pixels: 720 × 480 |
| | Scaling factor: 1 |
| Subtitle image | Frame aspect: 4:3 |
| | The number of pixels 720 × 480 |
| Sub-image | Frame aspect: 16:9 |
| | The number of pixels: 1920 × 1080 |

When combining the main image 50 and the subtitle image 54 with the sub-image 52, the AV input/output circuit 184 determines whether the pixel aspect is different between the sub-image 52, and the main image 50 and the subtitle image 54. The AV input/output circuit 184 determines the pixel aspect based on the frame aspect and the number of pixels. In this example, the pixel aspect of the sub-image is 1:1, but the pixel aspect of the main image and the subtitle image is 1:0.9. Therefore, the pixel aspect is different between the sub-image 52, and the main image 50 and the subtitle image 54. For this reason, the AV input/output circuit 184 executes the pixel converting process.

The AV input/output circuit 184 converts the pixels of the main image 50 so that the pixel aspect of the main image 50 matches with the pixel aspect of the sub-image 52. For example, the AV input/output circuit 184 adjusts the number of pixels so that the ratio of the horizontal pixel number to the vertical pixel number of the main image becomes 4:3.

In other words, the AV input/output circuit 184 downscales the main image of 720×480 pixels in the horizontal direction based on a pixel conversion parameter (= 8/9). As a result, the main image of 720×480 pixels is downscaled to the image of 640×480 pixels, resulting in the pixel aspect 1:1. Similarly, also the subtitle image 54 is downscaled in the horizontal direction according to the downscaling of the main image 50. When a format of the image is determined, the pixel conversion parameter may be stored in a memory of the 3D image display controller 1 in advance. Alternatively, the pixel conversion parameter may be calculated based on information obtained from the image stream.

After the completion of the pixel converting process, the scaling process based on the scaling factors is executed. The AV input/output circuit 184 upscales or downscales the main image and the subtitle image based on the scaling factors. In this example, since the scaling factor is 1 as described in the premise, the main image and the subtitle image are not upscaled nor downscaled.

The AV input/output circuit 184 adjusts the parallax information of the subtitle image based on the downscaling magnification of the main image (in other words, the pixel conversion parameter and the scaling factor). For example, since the downscaling magnification of the main image is calculated by multiplying the pixel conversion parameter (= 8/9) by the scaling factor (=1), resulting in 8/9, the AV input/output circuit 184 adjusts the parallax information Z about the subtitle information based on the calculated value. Thereafter, the AV input/output circuit 184 combines the downscaled main image 50 and subtitle image 54 with the sub-image 52.

As described above, when the pixel aspects of the main image and the sub-image are different, the AV input/output circuit 184 adjusts the parallax information Z about the subtitle image using the value calculated in consideration of the pixel conversion parameter as well as the scaling factor. Accordingly, the parallax of the subtitle image can be adjusted more accurately.

### 6.3 Third Example of Adjustment of Parallax Information

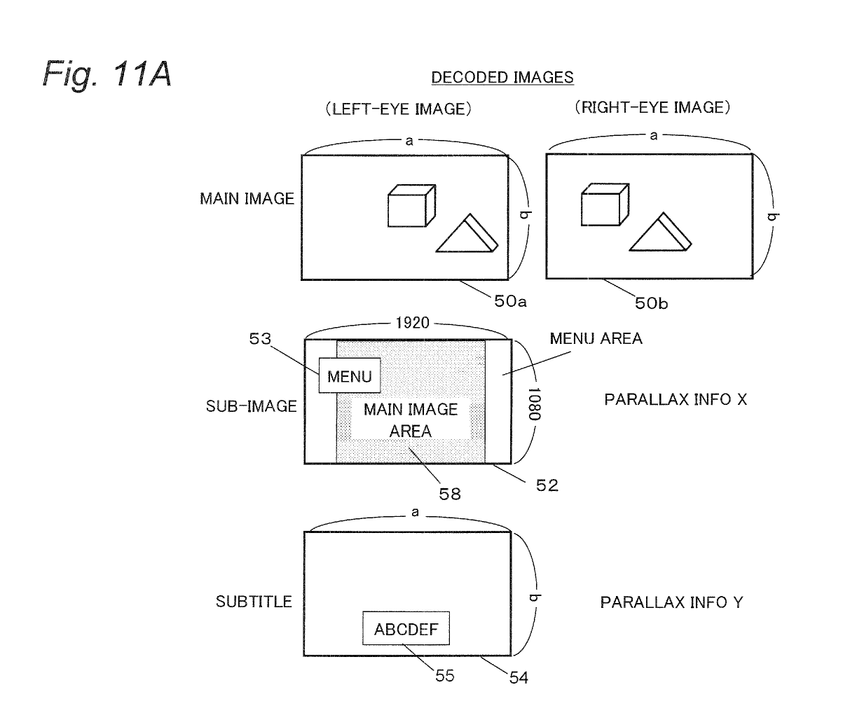

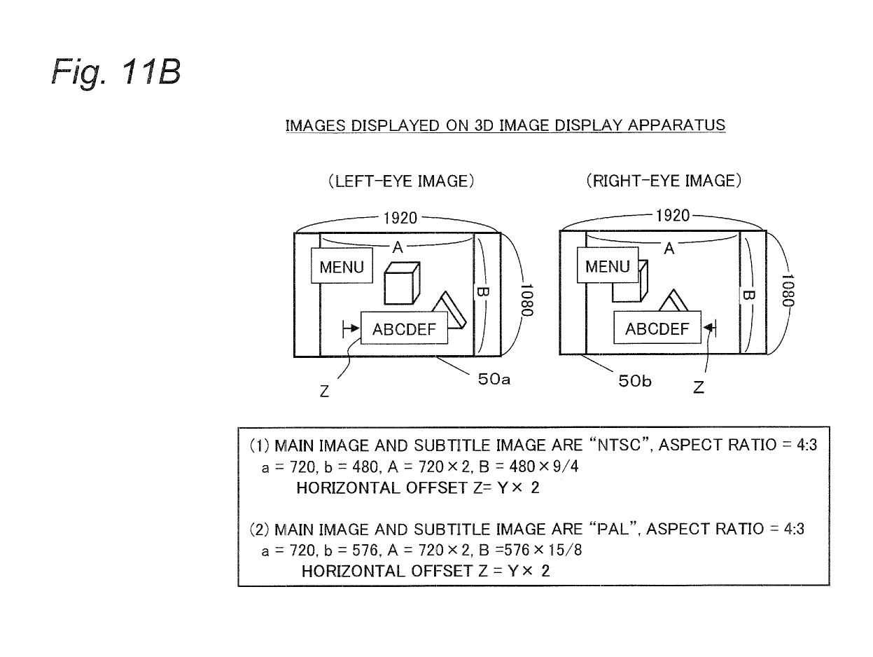

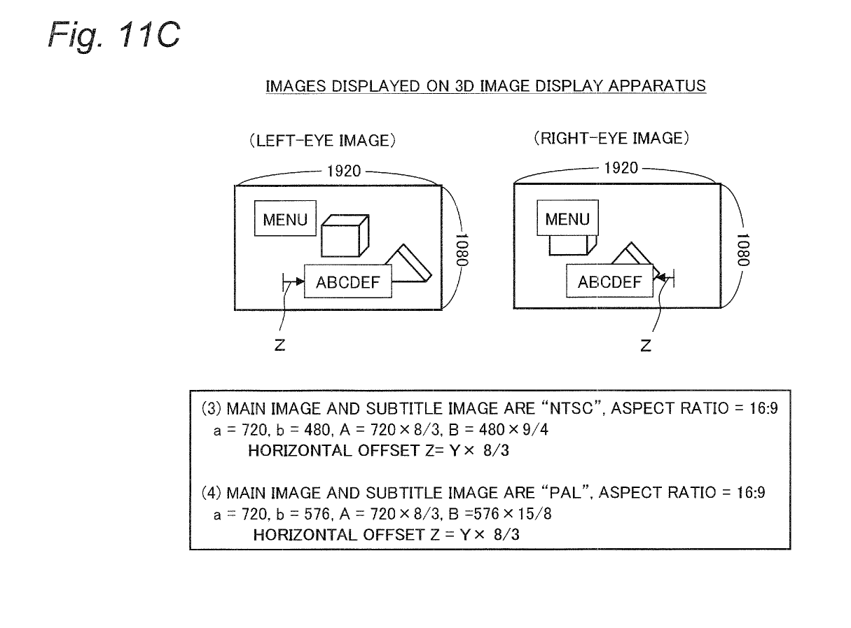

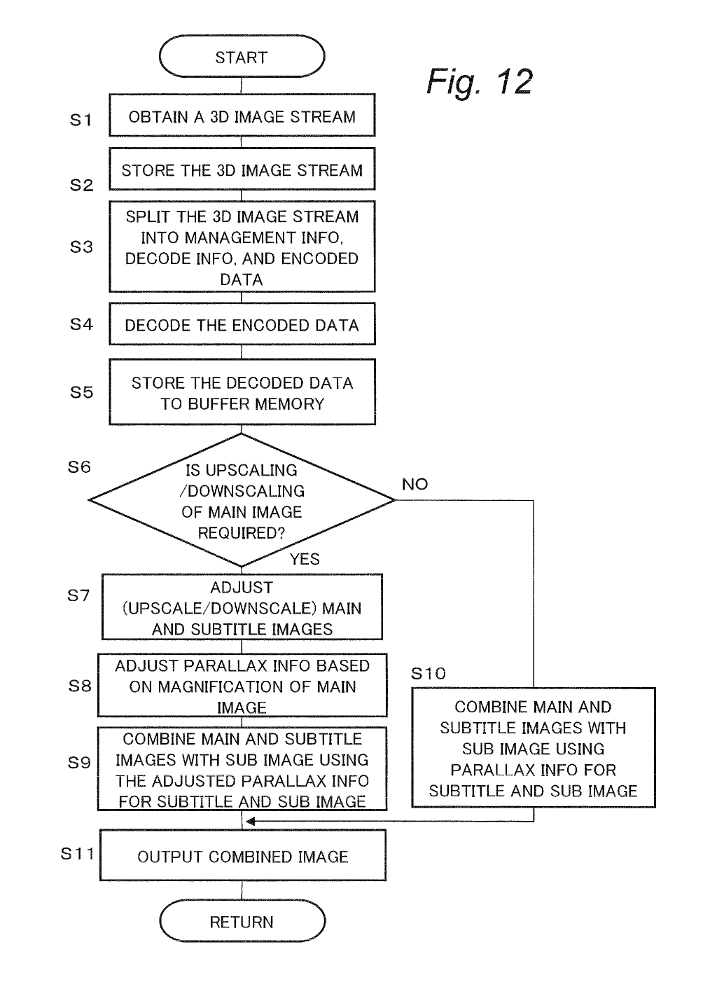

A third example of adjustment of the parallax information is described below. The description refers to the adjustment of the parallax information of the subtitle image (horizontal offset amount Z) when the main image 50 and the subtitle image 54 shown in FIG. 11A are combined to generate a combined image shown in FIG. 11B or 11C.

Conditions (1) to (2) in FIG. 11B are conditions for displaying the upscaled or downscaled main image 50 on a partial area 58 of the sub-image 52, when both the main image 50 and the subtitle image 54 are SD (Standard Definition) images, the frame aspects are 4:3, and the sub-image 52 is an HD image. Conditions (3) to (4) in FIG. 11C indicate conditions for displaying the upscaled or downscaled main image on the partial area 58 of the sub-image 52, when both the main image 50 and the subtitle image 54 are SD images, the frame aspects of the main image 50, the subtitle image 54 are 16:9, and the sub-image 52 is an HD image. In the examples in FIGS. 11B and 11C, when the display of the sub-image is made to be ON, the parallax information of the subtitle image is adjusted according to the upscaling or downscaling magnification of the main image in consideration of the pixel conversion.

For example, as described in the condition (4) in FIG. 11C, the case where the main image of 720×576 pixels is upscaled to the image of 1980×1080 pixels is considered. In this case, the adjusted parallax information (Z) about the subtitle image can be obtained by Y×8/3. This is described in detail below.

The condition (4) in FIG. 11C premises an image stream under the following condition.

<Image stream>

| | |
|---|---|
| Main image | Frame aspect: 16:9 |
| | The number of pixels: 720 × 576 |
| | Scaling factor: 15/8 |
| Subtitle image | Frame aspect: 16:9 |
| | The number of pixels: 720 × 576 |
| Sub-image | Frame aspect: 16:9 |
| | The number of pixels: 1920 × 1080 |

When combining the main image 50 and the subtitle image 54 with the sub-image 52, the AV input/output circuit 184 determines whether the pixel aspects are different between the sub-image 52, and the main image 50 and the subtitle image 54 based on the frame aspects and the number of pixels. In this example, since the pixel aspects are different, the AV input/output circuit 184 executes the pixel converting process.

The AV input/output circuit 184 performs the pixel conversion of the main image so that the pixel aspect of the main image matches with the pixel aspect of the sub-image. For example, the AV input/output circuit 184 adjusts the number of pixels so that the ratio of the number of horizontal pixels to the vertical pixels of the main image becomes 16:9.

In other words, the AV input/output circuit 184 upscales the main image of 720×576 pixels in the horizontal direction based on the pixel conversion parameter (64/45). As a result, the main image of 720×576 pixels is upscaled to an image of 1024×576 pixels. The subtitle image is also upscaled similarly to the main image.

After the pixel converting process, the scaling process based on the scaling factors is executed. The AV input/output circuit 184 upscales or downscales the main image and the subtitle image based on the scaling factors. Since the scaling factor is 15/8, the upscaling process is executed as follows.

For example, the AV input/output circuit 184 upscales the main image of 1024×576 pixels to an image of 1980×1080 pixels based on the scaling factor (=15/8). The subtitle image is upscaled similarly.

The AV input/output circuit 184 adjusts the parallax information of the subtitle image based on the downscaling magnification of the main image (in other words, the pixel conversion parameter and the scaling factor). For example, the downscaling magnification of the main image is calculated by multiplying the pixel conversion parameter (=64/45) by the scaling factor (=15/8), resulting in 8/3, and thus the AV input/output circuit 184 adjusts the parallax information of the subtitle image using the calculated value (8/3). Thereafter, the AV input/output circuit 184 combines the main image and the subtitle image with the sub-image. At this time, in the unsealed main image and subtitle image, a portion of the main image protruded from the area 58 may be cut off.

As described above, when the pixel aspects of the main image and the sub-image are different, the AV input/output circuit 184 adjusts the parallax information of the subtitle image in consideration of the pixel conversion parameter as well as the scaling factor. Accordingly, the parallax information of the subtitle image can be adjusted more accurately.

The above examples are only examples of the processes for upscaling and downscaling the main image, and the main image may be upscaled or downscaled with any magnification. Also in this case, the parallax information of the subtitle image is adjusted according to the upscaling/downscaling magnification of the main image.

### 7. Exemplary Operation of 3D Image Display Controller

An exemplary operation of the 3D image display controller 1 is described with reference to a flowchart in FIG. 12. This exemplary operation describes the case where a 3D image stream included in a broadcast wave obtained by the antenna 5 is displayed on the 3D image display apparatus 2. This exemplary operation refers to an operation of the 3D image display controller 1 in the state that the subtitle display is ON and the sub-image display is ON.

The LSI 18 controls the tuner 2 so as to obtain the 3D image stream from the broadcast wave received by the antenna 5 (S1). The LSI 18 stores the obtained 3D image stream in the buffer memory 16 (S2). The LSI 18 reads the 3D image stream stored in the buffer memory 16 and splits the 3D image stream into management information, decode information, and encoded data (S3). The LSI 18 stores the split information in the buffer memory 16. The LSI 18 decodes the encoded data based on the decode information (S4), and stores the decoded 3D image data in the buffer memory 16 (S5).

The LSI 18 determines whether it needs to upscale or downscale the main image (S6). The method for determining the necessity of upscaling/downscaling is as described before.

When it does not need to upscale or downscale the main image, the LSI 18 combines the subtitle image and the sub-image with the main image based on the parallax information of the subtitle image and the parallax information of the sub-image (S10). In this case, for example, the combined image shown in FIG. 6B is generated.

On the other hand, when it needs to upscale or downscale the main image, the LSI 18 upscales or downscales the main image and the subtitle image (S7). The subtitle image is upscaled or downscaled with the same upscaling or downscaling magnification as that of the main image. However, the magnification does not always have to be the same, and thus the subtitle image may be upscaled or downscaled with any magnification, or the subtitle image does not have to be upscaled nor downscaled. The LSI 18 adjusts the parallax information of the subtitle image according to the upscaling or downscaling magnification in the horizontal direction of the main image (S8). The upscaling/downscaling of the main image and the adjustment of the parallax information of the subtitle image are as described before.

Thereafter, the LSI 18 combines the subtitle image with the main image based on the adjusted parallax information (S9). Further, the LSI 18 combines the main image combined with the subtitle image with the sub-image (in predetermined area). An icon menu included in the sub-image is combined with the combined image (main image, subtitle image, sub-image) based on the parallax information of the sub-image. For example, the combined image shown in FIG. 9B is generated.

The LSI 18 outputs the combined image to the 3D image display apparatus 2 (S11). The above operation is repeated so that the LSI 18 sequentially outputs the display screen to the 3D image display apparatus 2.

### 7.1 Another Image Combining Process

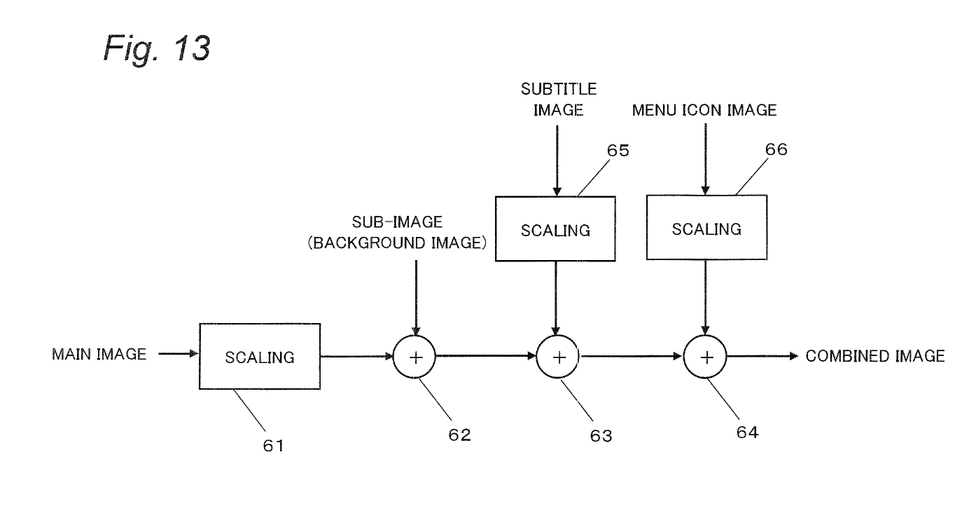

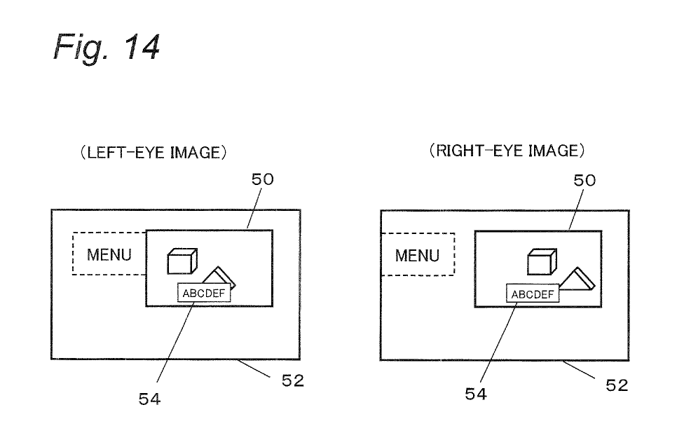

In the above example, the subtitle image is combined with the main image, and then the main image combined with the subtitle image is combined with the sub-image, but the combining process is not limited to this. A sequence of another combining process is described below. FIG. 13 shows a functional block diagram of the AV input/output circuit 184 relating to another image combining process. A first scaling block 61 inputs a main image, and upscales or downscales the main image according to the aforementioned method. The first scaling block 61 further determines a position of a sub-image at which the main image is disposed (offset value Px, Py (see FIG. 7)). Thereafter, a first adder 62 combines the upscaled or downscaled main image with the sub-image based on the determined position.

A second scaling block 65 upscales or downscales a subtitle image with the same magnification as the upscaling or downscaling magnification of the main image. Further, the second scaling block 65 determines parallax information (Z) about the subtitle image. The method for determining the parallax information (Z) is as described above. A second adder 63 combines the upscaled or downscaled subtitle image with the sub-image (or the main image) based on the position of the main image 50 and the determined parallax information (Z).

A third scaling block 66 upscales or downscales a menu icon, as required, and obtains parallax information of the menu icon. A third adder 64 combines the upscaled or downscaled menu icon with the sub-image based on the position of the main image 50 and the obtained parallax information.

In the above manner, the main image, the subtitle image, and the menu icon are combined with the sub-image.

The upscaling/downscaling magnification of the main image may be different from the upscaling/downscaling magnification of the subtitle image and the menu icon. Like the configuration shown in FIG. 13, the main image and the subtitle image are upscaled or downscaled respectively and then are combined. As a result, the upscaling/downscaling magnifications can be independently set, so that general versatility at the time of generating the sub-image increases.

### 8. Conclusion

The 3D image display controller 1 according to the embodiment includes the LSI 18 that obtains data of the main image as an image enabling stereoscopic view, data of the subtitle image to be combined with the main image and be displayed, and the parallax information for defining a display position in a depth direction of the subtitle image in stereoscopic view of the subtitle image, the LSI 18 that upscales or downscales the main image, the LSI 18 that adjusts the position information based on the magnification of upscaling or downscaling the main image, and the LSI 18 that combines the subtitle image with the upscaled or downscaled main image based on the adjusted position information so that the subtitle image can be viewed stereoscopically.

With this arrangement, the 3D image display controller 1 can adjust the display position of the subtitle image in the depth direction according to the upscaling or downscaling magnification of the main image. Accordingly, even when the main image is upscaled or downscaled, the user has less uncomfortable feeling in the display position in the depth direction of the subtitle image added to the main image.

The 3D image display controller 1 according to the embodiment includes the LSI 18 that obtains data of the main image as an image enabling a stereoscopic view, data of the subtitle image combined with the main image and be displayed, and data of the sub-image, the LSI 18 that upscales or downscales the main image, the LSI 18 that combines the upscaled or downscaled main image and the sub-image so that the upscaled or downscaled main image is displayed on a partial area of the sub-image, a second scaling unit that upscales or downscales an additional image, and a second LSI 18 that combines the upscaled or downscaled additional image with the combined image of the main image and the sub-image.

With this arrangement, the upscaling/downscaling magnifications of the main image and the subtitle image can be independently set, which can be applied to generation of various sub-images. For example, the above arrangement is effective particularly for the case where: the main image and the sub-image are recorded, as a 3D image stream, in the optical disc; the subtitle image is recorded, as an additional stream, in the server on the network; and the number of pixels of the main image is different from that of the subtitle image. For example, it can be applied to the case where the 3D image display controller combines an image content recorded on the optical disc with the subtitle image downloaded from the network and reproduces the content combined with the subtitle image. In the above case, when the scaling circuits for the main image and the subtitle image can be realized by one circuit, the images cannot be suitably scaled because the number of pixels of the main image and the subtitle image are different from each other. In this situation, the suitable image cannot be provided to the user even if desired. Therefore, like the embodiment, the separate scaling circuits are provided for the main image and the subtitle image, respectively, so that the suitable scaling between the main image and the subtitle image can be achieved.

The 3D image display controller is one example of a 3D image combining apparatus. Further, the subtitle image is one example of an additional image. The parallax information of the subtitle image is one example of position information representing the display position in the depth direction. The LSI 18 is one example of an obtaining unit, a scaling unit, an adjusting unit, a combining unit, and an additional image scaling unit.

The above example is shown as one embodiment of the present invention. However, the idea of the present invention is not limited to the above specific embodiment. That is, various other modifications, variations, and alternatives will be apparent to a person skilled in the art.

### INDUSTRIAL APPLICABILITY

The above embodiment can be applied to a television set capable of displaying 3D images, a recording/reproducing apparatus or player connectable to a display apparatus.

1. A three-dimensional image combining apparatus comprising:
an obtaining unit configured to obtain data of a main image as an image enabling stereoscopic view, data of an additional image to be combined with the main image and be displayed, and parallax information for defining a display position in a depth direction of the additional image in stereoscopic view of the additional image;
a scaling unit configured to upscale or downscale the main image;
an adjusting unit configured to adjust the parallax information based on a magnification of upscaling or downscaling the main image; and
a combining unit configured to combine the additional image with the upscaled or downscaled main image based on the adjusted parallax information so that the additional image can be viewed stereoscopically.

2. The three-dimensional image combining apparatus according to claim 1, wherein
the obtaining unit further obtains data of a sub-image with which the main image is to be combined and a scaling magnification of the main image used for combining the main image with the sub-image,
when a pixel aspect as a ratio of vertical length to horizontal length of pixels composing an image is different between the main image and the sub image, the scaling unit upscales or downscales the main image based on a pixel conversion parameter and the scaling magnification, the pixel conversion parameter being a coefficient which is determined to match the pixel aspect of the main image with the pixel aspect of the sub-image.

3. The three-dimensional image combining apparatus according to claim 1, wherein
the obtaining unit further obtains data of a sub-image with which the main image is to be combined and a scaling magnification of the main image used for combining the main image with the sub-image,
when a pixel aspect as a ratio of vertical length to horizontal length of pixels composing an image is different between the main image and the sub-image, the scaling unit converts a number of pixels of the main image so that the pixel aspect of the main image matches with the pixel aspect of the sub-image, and then upscales or downscales the main image based on the scaling magnification.

4. The three-dimensional image combining apparatus according to claim 1, further comprising a second scaling unit configured to upscale or downscale the additional image,
wherein a magnification for upscaling or downscaling the additional image is same as a magnification for upscaling or downscaling the main image.

5. The three-dimensional image combining apparatus according to claim 1, wherein the position parallax information is a shift amount of the additional image with respect to the main image.

6. The three-dimensional image combining apparatus according to claim 1, wherein the additional image is an image including subtitle information.

7. A three-dimensional image combining apparatus for combining a main image as an image enabling stereoscopic view with a sub-image, the apparatus comprising:
an obtaining unit configured to obtain data of the main image, data of an additional image to be combined with the main image and be displayed, and data of the sub-image;
a first scaling unit configured to upscale or downscale the main image;
a first combining unit configured to combine the upscaled or downscaled main image and the sub-image so that the upscaled or downscaled main image is displayed on a partial area of the sub-image;
a second scaling unit configured to upscale or downscale the additional image; and
a second combining unit configured to combine the upscaled or downscaled additional image with the combined image of the main image and the sub image.

8. The three-dimensional image combining apparatus according to claim 7, wherein a magnification for upscaling or downscaling the additional image is same as a magnification for upscaling or downscaling the main image.

9. The three-dimensional image combining apparatus according to claim 7, wherein the additional image is an image including subtitle information.

10. A three-dimensional image combining method, comprising:
obtaining data of a main image to be presented stereoscopically, data of an additional image to be combined with the main image and be displayed, and parallax information for defining a display position in a depth direction of the additional image in stereoscopic view of the additional image;
upscaling or downscaling the main image;
adjusting the parallax information based on a magnification of upscaling or downscaling the main image; and
combining the additional image with the upscaled or downscaled main image based on the adjusted parallax information so that the additional image can be viewed stereoscopically.
